(19) United States
(12) Patent Application Publication
(10) Pub. No.: US 2007/0235482 A1
(43) Pub. Date: Oct. 11, 2007

(54) Golf Cart Storage Device

(76) Inventors: Jacques Robert Laborie, Oakville (CA); Thomas Raymond Laborie, North York (CA); Donald Stuart Gilpin, Georgetown (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 11/278,476

(22) Filed: Apr. 3, 2006

(51) Int. Cl. B60R 9/00

(52) U.S. Cl. 224/274

(57) ABSTRACT

A storage unit for attachment to the rear support columns of the roof of a motorized golf cart is disclosed, comprising a generally rectangular construction, including a bottom shelf, side walls, one back wall, optionally one or more internal dividers, and a cover to enclose a storage space. The unit maybe insulated, and may additionally comprise a temperature adjustment means such as a heater or a refrigeration device. The unit is suitably dimensioned for attachment to any golf cart, and preferably includes a display device, such as a plasma or LCD screen attached to the back of the storage unit.

### FIELD OF THE INVENTION

The present invention relates to the field of storage devices, and in particular, relates to storage devices that may be removably and portably attached to a motorized golf cart. The storage device may then be used, for example, to store food, drinks, golf balls, tees, hats, clothing, or the like, or other consumable goods, while the golf cart is in use.

### BACKGROUND OF THE INVENTION

Golf is an increasingly popular game which requires its participants to traverse long distances over lengthy golf courses in pursuit of the object of the game. Each participant in the game generally must carry a complete set of golf clubs and related accessories, all of which are most-commonly carried in a standard golf bag. In an average game of golf, the participant will walk and carry his or her golf clubs and accessories over a distance of four to five miles.

To increase the speed of play of the game and to minimize fatigue, the participants will frequently utilize motorized golf carts. Rather than walking the distance of the course while carrying golf clubs and accessories, the participants will then ride in the carts over the distance of the golf course.

A standard motorized golf cart is constructed with seating for two participants, and with storage areas for two sets of golf clubs in standard golf club bags. While some golf carts are constructed without roofs or coverings over the seating area, roofs are a standard option. The roof structures are generally designed to shield the golfers from rain and other inclement weather, and to provide shade from intense sun. The roofs are typically held in place by a series of support columns which are generally fitted to each corner of the cart.

During play of the game, the participants will frequently carry with them, either on their persons or in storage compartments in their golf club bags, a variety of accessories that may be used or desired in the play of the game. This includes, for example, extra golf balls, golf tees, towels, sweaters, sunglasses, hats, shoes, and other articles of clothing. Because of the inconvenience of frequently reaching into storage compartments on a golf club bag for these accessories, the participants who utilize motorized golf carts will place these items in more convenient locations in and around their golf carts.

Most golf carts are constructed with storage areas for these items, but generally, this storage area is fairly limited. Although many golf carts have trays molded into their frames, the trays are fairly small in size and do not provide for secure and stable storage of items. Also, can or bottle carriers can be provided which will fit the exterior dimensions of a typical soda can or soda bottle. However, only one or two such can carriers are typically provided for each passenger.

The typical golf cart also has a wire basket mounted behind the passenger seat, and in front of the stored golf bags. While such baskets are large enough, typically, to hold a cooler, most golfers use this basket for storage of coats, hats, sweaters, club head covers and the like. Further, most golf carts are not equipped with a container which fits within this wire basket which means that the golfer, if permitted by the golf course, must bring his or her own container, which is typically a conventional cooler or bag. This arrangement is not suitable for provision of consumable items to the golfer by the golf course operator.

To supply the golfers with these consumable products, most golf courses have golf “pro-shops” adjacent to the golf course which sell golfing accessories and equipment, canned or bottled beverages, packaged food or other items to the golfers for them to take with them while golfing. Also, the golf course may establish so-called “half-way” houses to sell food or the like on the course, or may provide motorized drink carts equipped to carry food and drinks on the course.

However, these half-way houses, and drink carts must be manned which leads to increased costs. Further, they are frequently not available at the times that the golfer wishes to have a food or drink item, and/or may not be operation at certain times. Also, having the golfer stop at the half-way house or at a drink cart, delays the progress of the golfer which increases the time taken for each round of golf.

For example, golfers commonly have to wait until the drink cart reaches them purchase various consumable goods. This wait can be long, and as a result, golfers often do not have the food, beverages and other consumable items they want or need at the time that they want or need them If a supply of these items was provided for them in their golf carts, golfers would be able to have such items whenever they want This would likely improve golfers' performance as they would be able to maintain hydration in hot temperatures and have the necessary nutrients to maintain optimum energy levels while playing. They would also have ready access to golf accessories, such as gloves, tees, extra balls and other items when the need arises. As a result, they would likely consume more of these items and the golf course operators would generate greater revenues from sales of these items.

It is to be noted though, that some golfers who desire to have food, beverages, extra golf balls and other golf accessories while on a golf outing will bring a supply of these items with them from sources other than the golf club's pro-shop. With respect to food and beverages, however, many golf courses discourage or even prohibit golfers from bringing some of these items from outside the golf course because allowing golfers to do so could be in violation of local laws or regulations, or could lead to damage of golf carts and/or the golf course because of the various containers used by golfers for these items. Further, allowing this practise, deprives the golf course operators of revenues generated from the sales of such items.

As such, the ability of golf course operators to generate revenues from sales of beverages, packaged foods and other consumable items is currently limited by what golfers can carry with them in the limited storage space on the golf cart, or which can be supplied to them by use of half-way houses, or by drink carts.

These limitations result in a lost opportunity to generate revenues from the sale of consumable items. Golf course operators are generally aware of the storage limitations of golf carts and the needs of golfers for various consumable items during a golf outing, and wish to adopt methods and devices which will increase the consumption of these consumable items.

The prior art includes a few containers or mounting means for containers intended for use in golf carts to carry beverages, food and other consumable items. For example, U.S. Pat. No. 5,620,125 to Duncan, et al. discloses a bumper attachable accessory support device. However, this device merely provides a bracket for holding conventional insulated coolers.

Still other prior art efforts have focused on providing a container for carrying refreshments or other consumable items in a golf cart through conventional coolers or storage containers configured to fit in an area of a golf cart that will not occupy space that is needed for other purposes. For example, U.S. Pat. No. 4,989,767 to Buchsbom discloses a golf cart cooler releaseably mountable on the font end of a motorized golf cart, U.S. Pat. No. 5,419,478 to Mauro, et al. discloses a steering column mounted cooler, U.S. Pat. No. 5,344,020 to Ferguson discloses a storage rack fitted to the underside of the roof of a motorized golf cart, U.S. Pat. No. 5,772,272 to Faddis discloses a “sun visor” with limited storage capability, and U.S. Pat. No. 6,183,029 to Deaton discloses a storage unit adapted to fit under the wire basket which is commonly found on a motorized golf cart, directly behind the occupant seats.

Other devices are described in U.S. Pat. No. 6,869,120 to Johnson Jr. et al., U.S. Pat. No. 6,641,192 to Eschenfelder, U.S. Pat. No. 5,419,478 to Mauro et al., and U.S. Pat. No. 6,601,745 to Tyrer.

Most of these devices however, are typically directed to space saving configurations of conventional storage devices for consumable products, and are not directed to the need to store consumable items, such as various golf accessories, food or beverages in a secure and optionally insulated container.

U.S. Pat. No. 6,786,303 to Allen discloses a container which is adapted to be stocked with consumable supplies for a golfer. As such, Allen addresses the need for providing an apparatus containing such items already installed and fully stocked when a golf cart is rented for a golf outing, and a method for golf course operators to increase revenues generated from sales by them of consumable items. However, his container is merely fitted within the wire basket that is commonly used for storage of the golfer's equipment. As such, it reduces the amount of storage space available to the golfer.

Accordingly, none of the aforementioned storage devices provide a container on a motorized golf cart in which consumable items can be stored for sale to the golfers, and which does not reduce the amount of storage space which is already currently available. The present invention, however, provides a new and useful apparatus capable of meeting these long-felt needs.

Accordingly, the present invention has as one of its objects the provision of a storage device for motorized golf carts that may be easily and readily used for storage of golfing accessories.

It is a further object of the present invention to provide a storage device that may be removably attached to any golf cart that has a roof.

Another object of the present invention is to provide a storage device that securely holds golfing accessories, food, drink or other consumables.

Yet another object of the present invention is to provide a storage device that may be used by more than one golf participant, and that preferably contains separate compartments to segregate different types of consumables.

Yet still another object of the present invention is to provide a storage devices which facilitates the provision of advertising space or materials, and/or provides a space for supplying the golfer with relevant information.

These and other objects of the invention will become apparent in light of the present specifications, drawings and claims.

### SUMMARY OF THE INVENTION

Accordingly, it is a principal advantage of the present invention to provide a storage unit on a motorized golf cart which is easily and readily used for storage of golfing accessories.

It is a further advantage of the present invention to provide a storage device that may be removably attached to any golf cart that has a roof support structure.

Another advantage of the present invention is to provide a storage device that securely holds golfing accessories, food, drink or other consumables.

Yet another advantage of the present invention is to provide a storage device that may be used by more than one golf participant, and that preferably contains separate compartments to segregate different types of consumables.

Yet still another advantage of the present invention is to provide a storage devices which facilitates the provision of advertising space or materials, and/or provides a space for supplying the golfer with relevant information.

The advantages set out hereinabove, as well as other objects and goals inherent thereto, are at least partially or fully provided by the motorized golf cart storage apparatus of the present invention, as set out herein below.

Accordingly, in one aspect, the present invention provides a golf cart storage unit which is adapted to be affixed to support columns, and preferably the rear, roof support columns, of a motorized golf cart, which storage unit comprises:
a support structure which support structure is operatively connectable to said support columns;
a storage device comprising:
   preferably essentially planar top, bottom and side surfaces, with said side surfaces being essentially upwardly disposed and generally perpendicular to said top and bottom surfaces, and said side surfaces being joined at each end to said top or bottom surface;
   a preferably essentially planar back surface, attached to at least one of a rear edge of said top, bottom or side wall surfaces, wherein said top, bottom, side and back surfaces define a storage space area; and
   optionally, an internal divider located within said storage space area which internal divider separates said storage space area into a plurality of storage areas which storage areas are preferably each adapted to receive one or more consumable items; and
wherein said golf cart storage unit is adapted to be fitted to said support columns so as to be located on said golf cart behind a golfer seated on a seat provided on said golf cart, and which is preferably immediately under the roof of said golf cart.

Additionally, the back surface of the golf cart storage unit has an inward surface facing inwards towards said storage area, and a outward surface facing outwards from said storage area, and wherein the outward surface comprises a display device. The display device may be a holder for written or printed material, but preferably, is an electronic display device, such as, for example, a plasma or LCD display screen.

In a further aspect, the present invention also provides a golf cart assembly comprising a golf cart having occupant seats and a roof which roof is attached to said cart using forward and rear roof supports, and which rear roof supports are located at least partially behind said seats, and a golf cart storage unit as defined hereinabove, which has been operatively affixed to said rear, roof support structure so as to be located immediately under said roof.

As such, the invention preferably provides a storage unit that is fitted to the roof structure supports of a golf cart that provides a storage area located immediately behind the occupants of the golf cart, over the basket commonly found on most carts, and which preferably includes a display screen that can be used to provide advertising, course information, or the like, to the golf cart user.

Alternatively, the storage unit may be simply attached to support columns that are provided for the sole purpose of holding the storage unit. In this embodiment, the roof may not be used. However, preferably, a roof is provided so that the storage unit is attached to the roof support structure, and preferably, to the rear roof support columns.

With this option, because the storage unit is under the roof of the cart, it is easily accessed by the individuals who are riding in the golf cart, and the accessories that are stored in the compartment remain shielded from the weather under all conditions.

Further, when desired, the golf cart can be fitted with multiple storage units, of the present invention.

The improved golf cart storage unit is preferably a generally rectangular box with planar surfaces which includes at least one, and may include multiple internal compartments to hold and segregate food, drink, golf accessories, including golf balls, tees, and articles of clothing, or the like. The storage space area of the unit is preferably facing forward so as to be accessible from inside the cart. The storage unit can be essentially permanently connected to the golf cart roof supports, but preferably is attached using devices which can be quickly removed, if for example, the golfer did not wish to have the storage unit attached. Alternatively, the golf cart storage unit might be constructed in a modular construction so that the golfers could select which, if any, modules they wish to take with them. These modules could then be affixed to, or placed into a permanently mounted support structure on the rear roof support columns.

Preferably, the golf cart storage unit also comprises removable or openable covers or lids which are fitted to at least part of the front surface of the storage unit These covers or lids are used to securely hold the food, drinks or accessories in various compartments while the golf cart is in motion or while it is parked on an incline.

The storage space area is also preferably cooled if food or drinks are contained in the storage unit. This can be accomplished by use of temporary cooling methods such as by using ice or other cooled materials. Alternatively, the storage unit could be connected to a cooling device such as a small refrigeration unit, which might be powered from the electrical system of the cart, or powered by a separate electrical system. The power for the cooling device might be provided from the cart battery or cart engine, but might also be powered by, for example, a separate battery or other electrical energy source. This might include, for example, solar electric panels which have been fitted to the golf cart.

Alternatively, heating means might also be provided to keep hot beverages, or the like, heated in some compartments. In general, therefore, temperature control means are preferably provided with the golf cart storage unit.

In the preferred embodiment, therefore, the golf cart storage unit of the present invention is adapted to be affixed to the rear, roof support columns of a motorized golf cart, and comprises:
a support structure which support structure is operatively connectable to said rear, roof support columns;
a storage device comprising:
   essentially planar top, bottom and side surfaces, with said side surfaces being essentially upwardly disposed and generally perpendicular to said top and bottom surfaces, and said side surfaces being joined at each end to said top or bottom surface;
   an essentially planar back surface, attached to at least one of a rear edge of said top, bottom or side wall surfaces, wherein said top, bottom, side and back surfaces define a storage space area, wherein said back surface of the golf cart storage unit has an inward surface facing inwards towards said storage area, and a outward surface facing outwards from said storage area, and wherein said outward surface comprises a display device;
   removable or openable covers or lids which are fitted to the front surface of the storage unit so as to cover at least part of said storage space;
   temperature control means for controlling the temperature within said storage space;
   at least one internal divider located within said storage space area which internal divider separates said storage space area into a plurality of storage areas which storage areas are each adapted to receive one or more consumable items; and
wherein said golf cart storage unit is adapted to be fitted to said rear, roof support columns so as to be located on said golf cart immediately under the roof of said golf cart, and behind a golfer seat provided on said golf cart.

### BRIEF DESCRIPTION OF THE DRAWINGS

Embodiments of this invention will now be described byway of example only in association with the accompanying drawings in which:

FIG. 1 is a front perspective view of a golf cart which includes a storage unit of the present invention which has been fitted within the golf cart structure;

FIG. 2 is a front perspective view of a preferred method for attaching a storage unit to a golf cart;

FIG. 3 is a top and front view of one configuration of a storage unit;

FIG. 4 is a top and front view of a second configuration of a storage unit;

FIGS. 5A and 5B are perspective, exploded views of a storage unit of the present invention, which have been fitted with display devices, and with a viewing shield;

FIG. 6 is a side view of a golf cart which has been fitted with the storage unit shown from FIG. 5B;

FIG. 7 is a rear view of the golf cart shown in FIG. 6 with the display device of FIG. 5B; and

FIG. 8 is a rear perspective view of a modified viewing shield.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

Further, in the present discussion, the term “golf cart” is used to refer to a small motorized cart which is commonly found on a golf course. As such, the present discussion of the drawings will be made with its primary application being the use of the storage unit on such a motorized golf cart. However, the skilled artisan will be aware that the unit might also be used in a wide variety of other motorized devices. This might include, for example, any small motorized cart, such as, for example, a motorized cart in use to transport people at an airport, or the like. As such, while the present discussion is directed with particular reference to its use in a golf cart, the skilled artisan would be aware that the present invention may be easily adapted for any moving vehicle used for work or pleasure having characteristics of a golf cart as described.

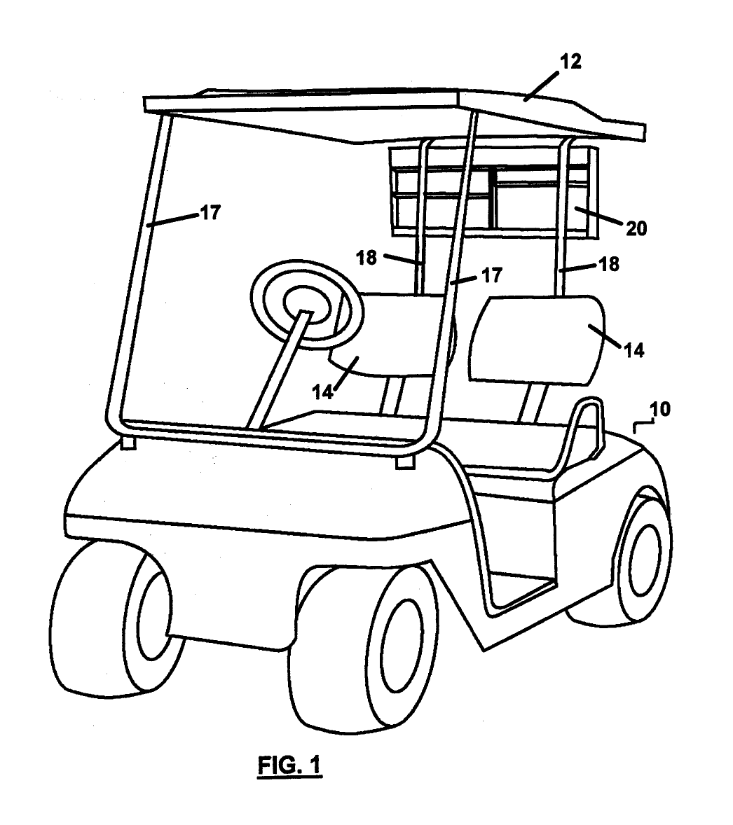

Referring to FIG. 1, a golf cart 10 is shown having a roof 12, occupant seats 14, front roof supports 17 and rear roof supports 18. The cart may additionally have a storage basket (not shown) located behind seats 14. Fitted behind seats 14, immediately under roof 12, and attached to rear roof supports 18, is a golf cart storage unit 20, of the present invention.

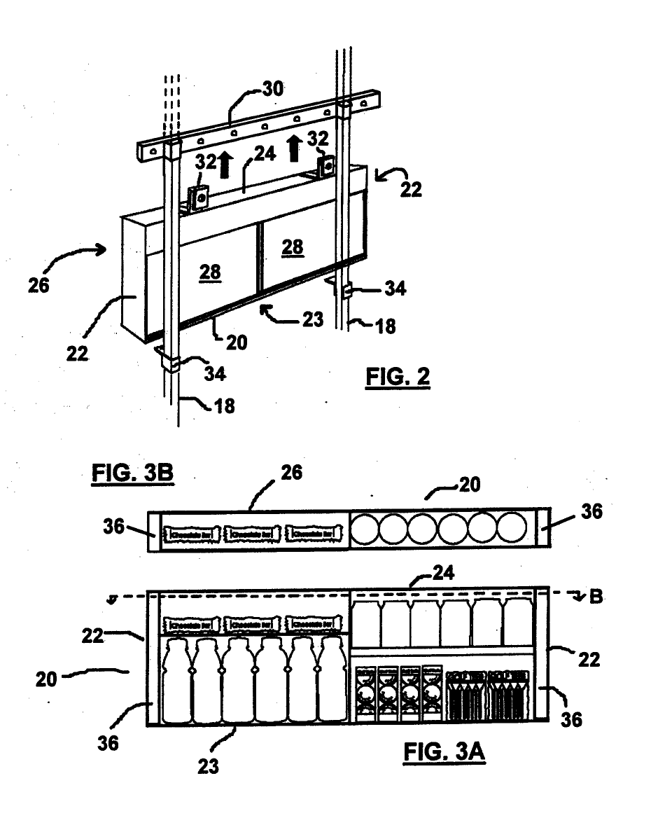

In FIG. 2, the details of construction of unit 20 are shown, including one possible attachment means. Unit 20 is essentially a rectangular box and has two planar side walls 22, a planar top surface 24, a planar bottom surface 23, a planar back surface 26, and a two piece sliding cover 28. Unit 20 is attached to golf cart 10 using a brace 30 which is bolted at each end to rear roof support columns 18. Brackets 32 are attached to top surface 24, and U-shaped so as to hang over brace 30 and optionally then be bolted to brace 30. Lower supports 34 are attached to roof support columns 18 and unit 20 can rest on supports 34.

Unit 20 can be quickly placed on golf cart 10 by hanging U-shaped brackets 32 over brace 30, and then lowering unit 20 until it rests on supports 34. Unit 20 can then optionally be bolted to brace 30.

The dimensions of unit 20 are such that it fits within the space provided between the golfers sitting on seat 14, a basket (when present) and the rear roof supports 18. The unit preferably has dimensions of about 30 to 40 cm in height, 50 to 100 cm wide, and 5 to 20 cm in depth. However, these dimensions can vary depending on the size of storage unit desired, and the space available within the golf cart structure.

Typically, the storage unit will have a weight of about 2 to 10 kg, depending on its structure and materials of construction. Further, the storage unit will typically hold about 5 to 20 kg of materials. As such, the support structure is preferably fabricated so as to hold this combined weight. Preferably, storage unit 20 is fabricated from a mixture of plastics, steel, aluminium or the like, although any suitable material might be used.

In operation, a user accesses the products within unit 20 by sliding a portion of cover 28 so that the user can reach inside of the storage space and then remove the desired item. The connection of cover 28 to unit 20 can include the use of a track (as shown) in which the cover doors can slide. Alternatively, cover doors can be attached to the unit by a hinge mechanism, and optionally a spring hinge mechanism, so that the doors automatically close. Numerous methods however, can be used to hold the cover doors or lids in place.

Cover 28 is preferably manufactured from a rigid clear plastic material so that the user can see the items contained in the compartments of the storage unit. A wide variety of materials might be used to produce cover 28, and various compartments might have opaque or translucent covers instead.

With the cover in place, storage unit 20 provides secure compartmentalization of the goods to be stored and is capable of stably storing both liquid and dry food and beverage items in an insulated environment as well as other dry goods and golf accessories.

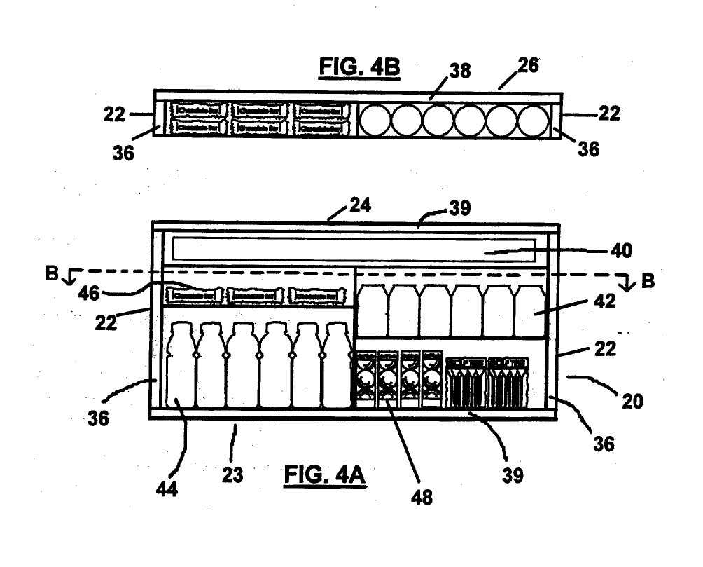

In FIGS. 3 and 4, two possible storage unit compartment configurations are shown with a front view (FIGS. 3A and 4A) and a top view (FIGS. 3B and 4B) along lines “B”. In FIG. 3, storage unit 20 includes 4 storage compartments for drinks in cans 42, drinks in plastic bottles 44, food 46, golf accessories 48, or the like. These storage compartments can be built as a single unit, or can be constructed as a series of modular compartments that can be mixed or matched to the wishes of the user.

Unit 20 has an insulation layer 36 on each side 22, which insulation layer 36 assists in keeping the contents inside of unit 20, cool. In FIG. 4, a second storage unit configuration 20′ is shown which additionally includes an additional insulation layer 39 on the top and bottom walls (23, 24), and a further insulation layer 38 on back surface 26, and an electrically powered refrigeration unit 40.

Refrigeration unit 40 can be any of a number of devices, but preferably is an electrically powered refrigeration unit which is connected to the electrical system of the motorized cart, or to a separate electrical system, as previously described. The refrigeration unit 40 can be used to cool at least one of the compartments of the storage unit.

In an alternative embodiment, any or all of the compartments could also be heated using a heating element in order to keep food or a hot beverage warm until consumed.

Insulation layers 36, 38 or 39 in FIGS. 3 or 4 can be any suitable insulating material, such as fibreglass insulating mats, styrofoam or the like, but might also simply be an air space. Further, these layers could also be replaced by a hollow shell, or the like, adapted to hold ice or other cooling or heating means.

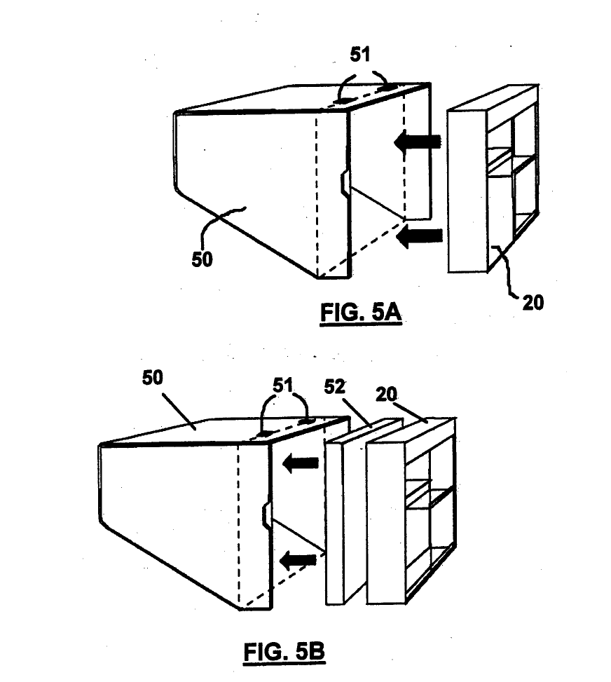

In FIG. 5A, storage unit 20 is also fitted with a protective shield 50 which is adapted to extend around three sides of cover 20, and thus provide additional protection to unit 20 from the sun, rain or the elements. This can also assist in maintaining a suitable temperature within the compartments of unit 20. Storage unit 20 is inserted into shield 50 in the direction of the indicated arrows, and the entire assembly can be fitted to cart 10 using the method described in respect of FIG. 2.

In FIG. 5B, storage unit 20 is additionally fitted with a plasma screen display 52 which faces rearward. Display 52 can be any suitable electronic display, but preferably is an LCD or plasma screen. Display 52 can also be powered by the electrical system of cart 10, or by a separate dedicated power supply, as previously described.

In this embodiment, shield 50 also acts as a screen to keep sunlight from falling on display 52, and thus facilitates viewing of display 52. It is intended that display 52 be viewed from behind cart 10, such as, for example, while the golfer selects a club from a golf bag. Information regarding the hole being played, such as yardages or a map, can be transmitted to the golfer using display 52. Alternatively messages such as weather warnings, pace of play indications, or the like, might also be transmitted.

Shield 50 is preferably fabricated from a rigid material, and may include optional hinges 51 to allow a portion of shield 50 to be moved in order to facilitate the removal of clubs from the golf bags which are resting on cart 10.

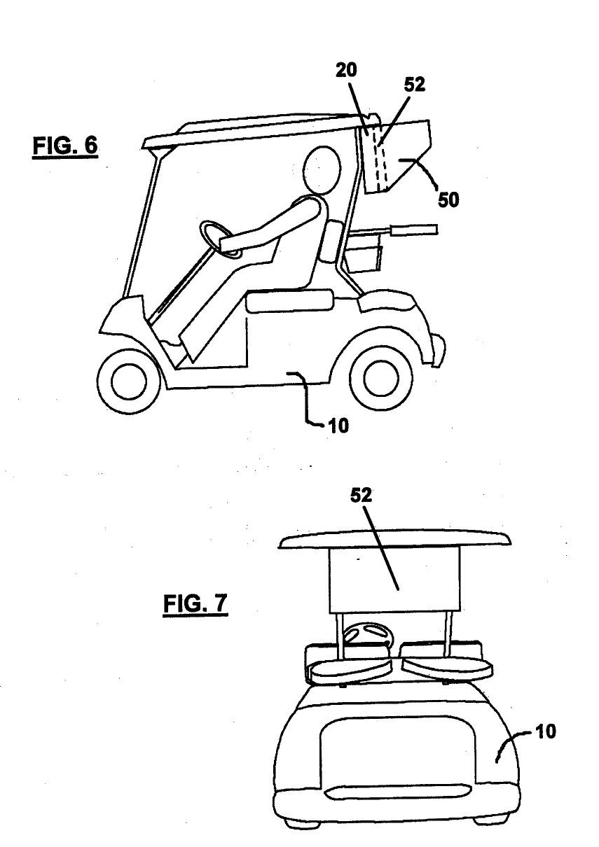

In FIGS. 6 and 7, a side view and rear view of golf cart 10 fitted with the storage unit 20, display 52 and shield 50 are shown.

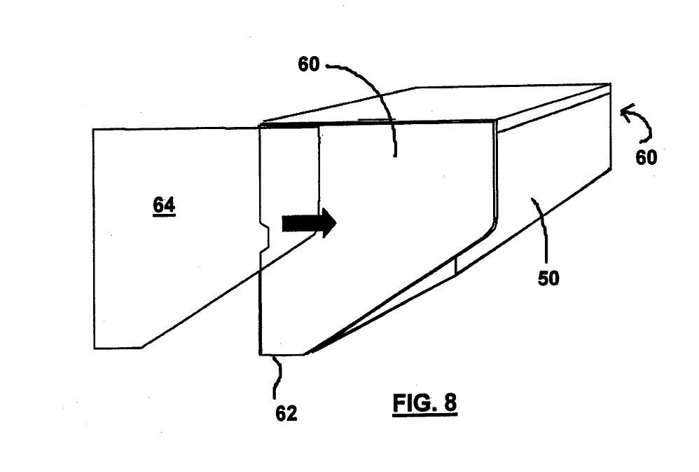

From FIG. 6, it can also be seen that the sides of shield 50 are clearly visible from the side of the cart. If desired, as shown in FIG. 8, the sides 60 of shield 50 can be fitted with a clear plastic holder 62 that can hold advertising, or other printed material 64, in order to provide additional cart space for advertising or the like.

In operation, a golf cart utilizing the apparatus of the present invention, eliminates the need for golf course operators to employ a golf course attendant to serve as a waiter/waitress traveling the golf course to take and fill orders from golfers for food, beverages and other consumable items by providing an apparatus that is mountable on golf carts to carry such items in a secure and climate-controlled manner. Persons utilizing the golf course thus carry with them in their rented golf carts an ample and easily accessible supply of such items and do not have to search or wait for a traveling golf course attendant to provide such items. The golf course operator thereby resolves the limitations problems of being able to sell of only so much of such items as can be carried by the golfer from the golf club's pro-shop, and separates the payment from the purchase; separating the payment from the purchase increases sales of products or services because it makes the purchaser feel less limited or resistant to making a purchase-the purchase can be paid for later, as part of a total bill, payment of which is oftentimes further deferred via credit card.

The apparatus of the present invention is preferably employed in the method of the present invention by supplying a storage unit which is stocked full of appropriate consumable items by the golf course operator prior to each golf cart. The golfer can select the items to be includes, or a standard selection of products can be provided. The golfer is thus provided with easy access to a supply of such items for his or her use, as required or desired. The amount of materials can be inventoried by the golf course operator after completion of the golf outing to identify the items consumed by the golfer during his or her golf outing, charging the golfer for the costs of such consumed items (either separately or as part of the golfer's total bill). The golf course operator then restocks the unit with a full supply of consumable items and the golf cart is returned to service.

Thus, it is apparent that there has been provided, in accordance with the present invention, a golf cart storage unit which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A golf cart storage unit which is adapted to be affixed to support columns fitted on a motorized golf cart having occupant seats, which golf cart storage unit comprises:
a storage unit support structure which support structure is operatively connectable to said support columns; and
a storage device comprising:
top, bottom and side surfaces, with said side surfaces being essentially upwardly disposed, generally perpendicular to said top and bottom surfaces, and being joined at each end to said top or bottom surface;
a back surface, attached to at least one of a rear edge of said top, bottom or side wall surfaces, wherein said top, bottom, side and back surfaces define a storage space area; and
optionally, an internal divider located within said storage space area which internal divider separates said storage space area into a plurality of storage areas which storage areas are each adapted to receive one or more consumable items; and
wherein said golf cart storage unit is adapted to be fitted to said support columns so as to be located on said golf cart behind said occupant seats.

2. A storage unit as claimed in claim 1 wherein said golf cart comprises a roof, and said support columns are fitted to said golf cart as roof support columns.

3. A storage unit as claimed in claim 2 wherein said support columns are rear roof support columns.

4. A storage unit as claimed in claim 3 wherein said storage unit is located immediately under the roof of said golf cart.

5. A storage unit as claimed in claim 1 wherein said storage device comprises essentially planar top, bottom, side and back surfaces.

6. A storage unit as claimed in claim 1 wherein said back surface comprises an inward surface facing inwards towards said storage area, and a outward surface facing outwards from said storage area.

7. A storage unit as claimed in claim 6 wherein said outward surface of said back surface comprises a display device.

8. A storage unit as claimed in claim 7 wherein said display device comprises an electronic display device.

9. A storage unit as claimed in claim 8 wherein said display device is a plasma or LCD display screen.

10. A storage unit as claimed in claim 8 wherein said storage unit additionally comprises a shield device for shielding said display device from sun and/or rain.

11. A storage unit as claimed in claim 1 comprising an internal divider located within said storage space area which internal divider separates said storage space area into a plurality of storage areas which storage areas are each adapted to receive one or more consumable items.

12. A storage unit as claimed in claim 11 wherein said consumable items comprise food, drink, hats, clothes, or golf accessories.

13. A storage unit as claimed in claim 11 wherein said internal divider establishes a plurality of separate modules.

14. A storage unit as claimed in claim 1 additionally comprising removable or openable covers or lids which covers or lids are fitted to at least part of the front surface of the storage unit, so as to securely hold the food, drinks or accessories in said storage areas while said golf cart is in motion or while it is parked on an incline.

15. A storage unit as claimed in claim 14 additionally comprising temperature control means.

16. A storage unit as claimed in claim 15 wherein said temperature control means is provided by a refrigeration unit or by a heater.

17. A storage unit as claimed in claim 15 wherein said temperature control means is provided by insulation around said storage unit

18. A storage unit as claimed in claim 15 wherein said temperature control means is powered by an electrical power system provided from said cart, or by a separate electrical system.

19. A storage unit as claimed in claim 18 wherein said electrical power system comprises solar electric panels which have been fitted to the golf cart.

20. A golf cart storage unit as claimed in claim 1 for use on a golf cart having occupant seats and a roof attached to said golf cart by front and rear roof support columns, and which storage unit is adapted to be affixed to said rear, roof support columns, and comprises:
a storage unit support structure which support structure is operatively connectable to said rear, roof support columns;
a storage device comprising:
essentially planar top, bottom and side surfaces, with said side surfaces being essentially upwardly disposed and generally perpendicular to said top and bottom surfaces, and said side surfaces being joined at each end to said top or bottom surface;
an essentially planar back surface, attached to at least one of a rear edge of said top, bottom or side wall surfaces, wherein said top, bottom, side and back surfaces define a storage space area, wherein said back surface of the golf cart storage unit has an inward surface facing inwards towards said storage area, and a outward surface facing outwards from said storage area, and wherein said outward surface comprises a display device;
removable or openable covers or lids which are fitted to the front surface of the storage unit so as to cover at least part of said storage space;
temperature control means for controlling the temperature within said storage space;
a shield device for shielding said display device from sun and/or rain; and
at least one internal divider located within said storage space area which internal divider separates said storage space area into a plurality of storage areas which storage areas are each adapted to receive one or more consumable items; and
wherein said golf cart storage unit is adapted to be fitted to said rear, roof support columns so as to be located on said golf cart immediately under the roof of said golf cart, and behind said occupant seats.
